(19) United States
(12) Patent Application Publication
(10) Pub. No.: US 2024/0343984 A1
(43) Pub. Date: Oct. 17, 2024

(54) A METHOD FOR THE PRODUCTION OF COMBUSTIBLES, PARTICULARLY ADVANCED BIOFUELS, FROM ORGANIC OR BIOLOGICAL WASTES

(71) Applicant: Archimede S.r.l., Caltanissetta (CT) (IT)

(72) Inventors: Gianluca TUMMINELLI, Caltanissetta (CT) (IT); Gaetano TUZZOLINO, Caltanissetta (CT) (IT); Fabio SANTORO, Caltanissetta (CT) (IT); Francesco DE PATRIZIO, Caltanissetta (CT) (IT); Eleonora Maria FLORIA, Caltanissetta (CT) (IT); Claudio SCARANTINO, Caltanissetta (CT) (IT)

(21) Appl. No.: 18/682,150

(22) PCT Filed: Aug. 4, 2022
(86) PCT No.: PCT/IB2022/057252

§ 371 Date: Feb. 8, 2024

(30) Foreign Application Priority Data
Aug. 9, 2021 (IT) 102021000021575

(51) Int. Cl. C10J 3/62; C01B 3/34; C10G 2/00; C10G 45/00; C10J 3/78; C10K 1/00; C10K 3/04; C10K 3/06; C10L 3/08; C10L 3/12

(52) U.S. Cl. CPC C10J 3/62; C01B 3/34; C10G 2/32; C10G 45/00; C10J 3/78; C10K 1/003; C10K 3/04; C10K 3/06; C10L 3/08; C10L 3/12; C01B 2203/0233; C01B 2203/025; C01B 2203/061; C01B 2203/062; C01B 2203/065; C01B 2203/1258; C10G 2300/42; C10G 2400/04; C10J 2300/0906; C10J 2300/0916; C10J 2300/0959; C10J 2300/0973; C10J 2300/0979; C10J 2300/1662; C10J 2300/1684; C10J 2300/169; C10J 2300/1807; C10J 2300/1846

(57) ABSTRACT

A method for the conversion of organic waste and/or biological waste into combustible products includes: feeding a first flow having organic waste and/or biological waste: performing a pyrolysis of the first flow to obtain one or more liquid pyrolysis products, one or more gaseous pyrolysis products, and one or more solid pyrolysis products; mixing the one or more solid pyrolysis products with a first aqueous flow, and subjecting the mixture to oxidation to obtain oxidation products; taking a first gaseous flow from the oxidation products; subjecting the one or more gaseous pyrolysis products to reforming, thereby obtaining one or more reforming products, taking a second gaseous flow from the reforming products, and subjecting the first gaseous flow and the second gaseous flow to catalytic hydrogenation, to obtain at least one first combustible.

### FIELD OF THE INVENTION

The present invention refers to the production of (bio)combustibiles, especially automotive fuels, which are defined as “advanced” in the Italian Law Decree “Promozione dell'uso del biometano e degli altri biocarburanti avanzati nel settore dei trasporti” [Fostering the use of biomethane and other advanced biofuels in the transportation sector], which transposes and implements the EU Directives n.98/30/CE, n.2009/73/CE and n.2009/28/CE regarding the network distribution of fuels obtained from an organic, synthetic or natural/biological raw material.

### KNOWN ART

The continuous and growing interest of the scientific research of national and the international policies in new methods and technologies aiming on one side at limiting or eliminating carbon dioxide emissions, and on the other side at recovering and exploiting certain sorts of waste, especially plastics or cellulose-based waste (paper/cardboard) or in any case deriving from materials containing carbon, pushes the research to develop sustainable industrial methods for transforming plastic or mixed waste into automotive fuels, while meeting the requirements and the regulations concerning environmental protection.

Nevertheless, the Applicant has observed that the scenario of known methods is still unable to achieve acceptable sustainability levels and/or products suited for the market: various known methods lead to the production of fuels which do not comply with national or international regulations, or cause emissions into the atmosphere which are still too high for the method to be considered fully sustainable.

Moreover, the Applicant has observed that the known technologies for the production of fuels or biofuels, precisely due to the limits outlined in the foregoing, allow only large-scale plants to be economically sustainable, to the detriment of small or medium-sized plants.

### OBJECT OF THE INVENTION

The present invention aims at solving the technical problems outlined in the foregoing. Specifically, the present invention aims at providing a method for the production of combustibles from organic raw materials such as, e.g., organic or biological wastes, which has a minimum environmental impact, which leads to the production of fuels complying with the specifications of national and international regulations, and which is economically sustainable even when it is implemented on small or medium-sized plants.

### SUMMARY OF THE INVENTION

The object of the invention is achieved by means of a method having the features of the claims that follow, which form an integral part of the technical disclosure provided herein in relation to the invention.

### BRIEF DESCRIPTION OF THE FIGURES

The invention will now be described with reference to the annexed Figures, provided by way of non-limiting example only, wherein:

FIG. 1 is a schematical block diagram of a method according to embodiments of the invention,

FIG. 2 is a schematical block diagram of a first section of the diagram of FIG. 1,

FIG. 3 is a schematical block diagram of a second section of the diagram of FIG. 1,

FIG. 4 is a schematical block diagram of a third section of the diagram of FIG. 1,

FIG. 5 is a schematical block diagram of a fourth section of the diagram of FIG. 1, and

FIGS. 6 and 7 are schematical block diagrams of a method according to further embodiments of the invention,

FIG. 8 is a general schematical representation of the method according to the invention.

### DETAILED DESCRIPTION

As a general foreword, the functional block diagram representations of the Figures generally show method steps which, in a way known in itself, may be implemented via known technologies. In the description, each block will be described primarily as regards the method steps, but this may be integrated with the description of the components implementing the step itself. If not explicitly stated otherwise, the use in some Figures of references (numbers and/or letters) which have already been used in previous or previously described Figures denotes the same element(s) of the previous or previously described Figures.

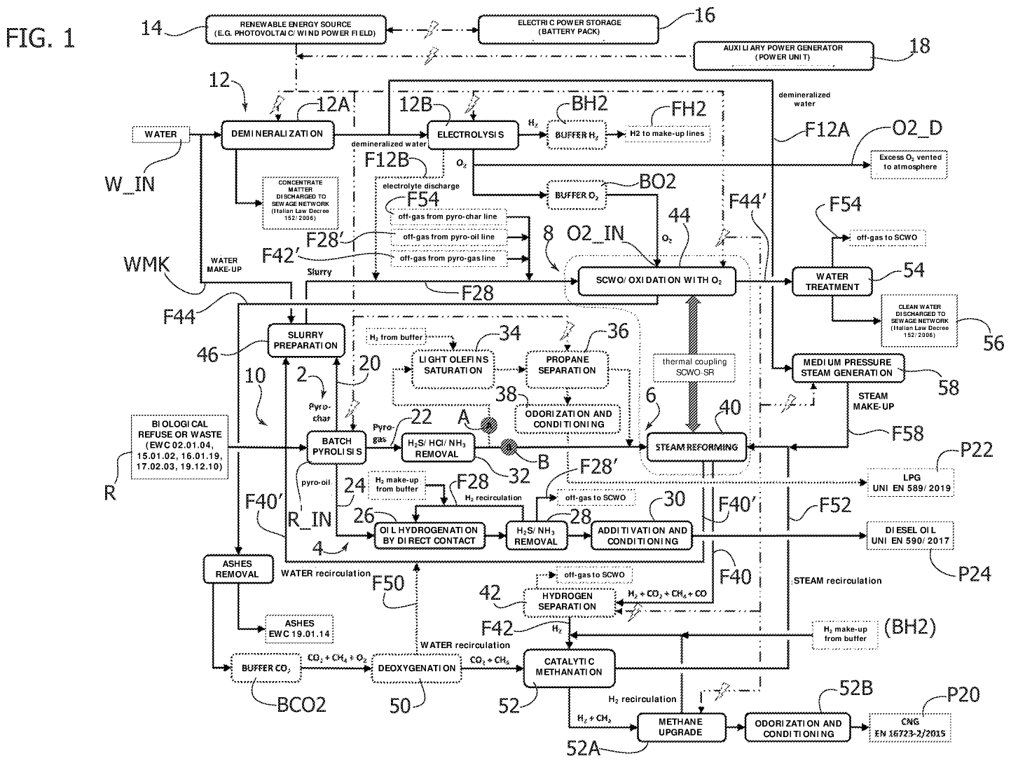

With reference to FIG. 1, reference number 1 generally denotes a method according to the invention, which is here represented for simplicity by way of a block diagram. The block diagram includes both numerical and text references, in order to simplify understanding.

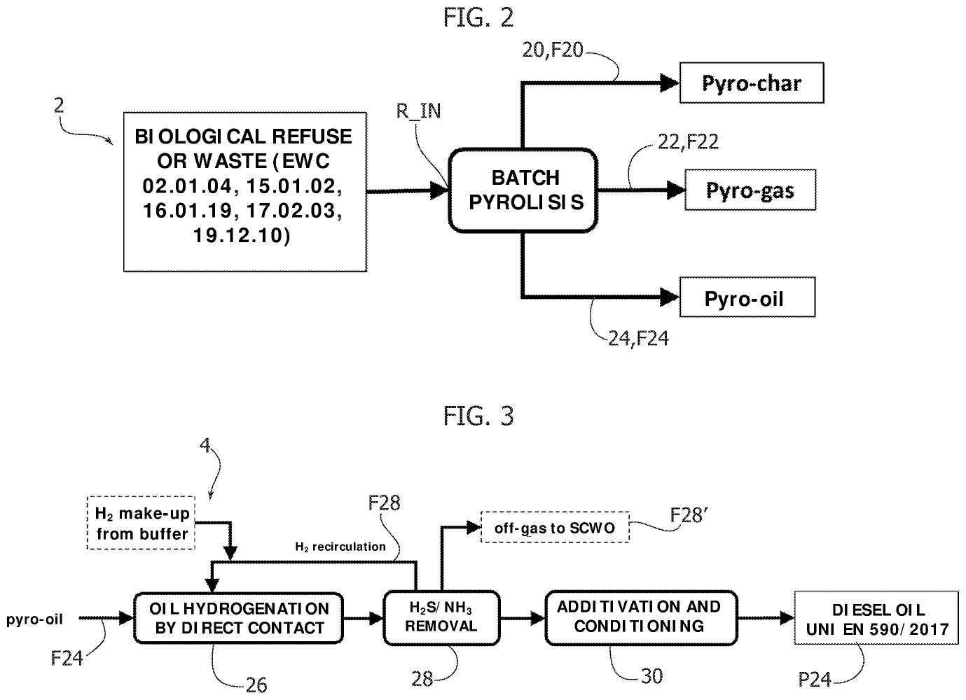

With reference to FIG. 1, and individually to FIGS. 2-5, method 1 includes the following sub-methods:
a first sub-method 1, comprising a preferably discontinuous process of pyrolysis pre-treatment, by which the input raw material R (R_IN) is transformed into intermediate products, which are destined to be subjected to the other sub-methods listed herein;
a second sub-method 4, comprising a continuous treatment process of the liquid pyrolysis products obtained in sub-method 2 (in the following, for brevity, denoted as “pyro-oil process”), and configured for obtaining, i.a., a combustible product meeting the diesel oil Specification EN 590/2017;
a third sub-method 6, comprising a continuous treatment process of the gaseous pyrolysis products obtained from sub-method 2 (in the following, for brevity, denoted as “pyro-gas process”), partly configured for producing liquefied propane gas (LPG) according to the Specification EN 589/2019 and/or configured, completely or in part, for obtaining an intermediate process flow which is rich in hydrogen, destined to be subsequently used in a treatment process of pyro-char, which will be discussed in the following paragraph;
a fourth sub-method 8, comprising a continuous treatment process of the solid pyrolysis products obtained from sub-method 2 (in the following, for brevity, “pyro-char” process), configured for obtaining a product having the specification of compressed natural gas (CNG) EN 16723-1/2015 or EN 16723-2/2015.

At least part of the four integrated sub-methods is functionally connected to the circulation of an aqueous flow, which is associated with numeral reference 10 and which comes partially from the intermediate or final products of the sub-methods themselves, and which is partially re-integrated by a input water flow W_IN. Conveniently, the input W_IN is routed in part (mainly) to a fifth sub-method 12 for the production of demineralized water and a subsequent electrolysis thereof for producing hydrogen and oxygen, which are two reagents employed in the other sub-methods. Specifically, the flow W_IN sent to the fifth sub-method 12 is subjected to demineralization (block 12A, which may be optional) and electrolysis (12B) or another technology or combination of technologies for the generation of gaseous hydrogen and gaseous oxygen. Preferably, the gaseous hydrogen and the gaseous oxygen are collected in respective buffer tanks BH2 (hydrogen) and BO2 (oxygen), wherefrom a flow of the corresponding gases is taken according to the needs of method 1 to be conveyed to one or more of the sub-methods included therein. The oxygen in excess may moreover be directly discharged into the atmosphere, flow O2_D.

The diagram of FIG. 1 moreover shows a possible total or partial connection of method 1 and of the functional stages involved therein with a renewable energy source 14 for the generation of the electric power needed to implement the sub-methods 2, 4, 6, 8.

Such a solution, together with the adoption of an electric storage system 16, may make the method 1 as a whole totally independent from an electric power supply from a traditional mains network, apart from the case of long periods of insufficient sunlight (if the renewable energy source is solar photovoltaic) or insufficient wind (in the case of wind energy), while keeping the possibility of using any other renewable energy source, if applicable, and keeping the possibility of using an auxiliary power generator 18.

Preferably, especially when the availability of renewable electric power is unreliable, because it consists of solar or wind energy, it is useful to also have temporary storage systems for the process reagents produced by means of water electrolysis, i.e., hydrogen and oxygen.

In this way it is possible to produce such reagents in excess in the periods of stronger sunshine or wind, in order to keep a constant operability of the process during the night or in the insufficiently productive periods of the RES.

In this case, the optimal condition for the sizing of the electric power and material storage (hydrogen and oxygen buffer) must be determined separately for each single case, depending on the combination of plural factors, i.a., on the installation site, on the capital and operational costs of the hydrogen and oxygen storage, on the cost of electric power.

If, on the other hand, the primary energy source has fossil origin or is always available in any other way, the considerations about the storage of power or of hydrogen and oxygen, listed in the foregoing, do not apply; however, as will be apparent in the following, it is in any case convenient to have material storage systems for the intermediate products from pyrolysis, because the latter is a process which is preferably performed discontinuously, unlike the other processes listed in the foregoing.

The method 1 according to the invention envisages inputting a given quantity R_IN of raw material R, including combustible waste material, preferably including plastics (for example corresponding to the EWC codes 02.01.04, 15.01.02, 16.01.19, 17.02.03 in the so-called European Waste Catalogue-EWC) or having a mixed composition (for example a secondary solid fuel corresponding to EWC code 19.12.10). However, this indication does not exclude the possibility of supplying other types of wastes which anyway have the features of an organic fuel, i.e., which contain, into their molecular structure, mutually linked carbon atoms such as, e.g., refuse from the treatment of the organic fraction of urban solid waste, or refuse or waste of biological origin, such as residues of anaerobic digestion, or leather scraps, tannery processing waste, exhausted tyres, “car fluff”, etc.

The so-called “end-of-waste” products of method 1, i.e., the products which are no longer classified as waste, are preferably renewable combustible products having a non-biological origin, which may be liquid (diesel oil for automotive uses according to the Specification EN 590/2017) and gaseous (compressed natural gas for automotive uses according to the Specification EN 16723-2/2015), or combustible products having a biological origin, if the supplied raw material comes from biological processing. In one of the preferred embodiments of the method, depending on the kind and composition of the input waste supplied in flow R_IN, specifically in the case of supplying waste having a high content of plastics, it is possible to identify a third useful product, which is a liquified propane gas (LPG, according to the Specification EN 589/2019).

Generally speaking, what is important to notice in the method according to the invention is that the products of method 1 (especially the combustible products) may all be classified, with the exception of ashes which are inert waste, as “end of waste”: in other words, what is obtained by means of the method according to the invention is a product or a group of products which are no longer wastes, but rather products having characteristics meeting regulatory specifications, and adapted to be directly used or marketed.

### Sub-Method 2: Pre-Treatment Pyrolysis Process

With reference to FIG. 2, the schematic representation provided therein describes the first sub-method 2 according to the invention, which corresponds to a pre-treatment pyrolysis process to which the starting waste (the raw material) conveyed in flow R_IN is subjected.

The input waste having flow R_IN, preferably deprived of the intrinsic content of ashes and inert material (metal, ceramic or glass material residues) is subjected, in pieces preferably smaller than 10 cm, to a first pyrolysis pre-treatment, which by way of example may be carried out in a rotary kiln reactor in a discontinuous mode, i.e., by executing a given ordered sequence of operations which define the so-called batch pyrolysis cycle, and which span from the charging of the organic matrix into the equipment to the discharging of the solid pyrolysis residues at the end of the work cycle, with a previous inertization of the internal volumes.

The input material is thus pre-treated in one or more batch pyrolysis cycles per day, each of which has conveniently a normalized duration including the minimum times necessary for the operations of charging, inertization, heating, reaction, cooling down, discharging (a typical work cycle is comprised from 8 to 24 hours, depending on the amount of the processed material) with the aim of determining the maximum number of daily batch cycles and therefore the yearly batch cycles, which determine the annual treatment capacity of the method 1 as a whole.

The normalization of the duration of the batch pyrolysis cycle and the contemporary presence of storage vessels or tanks of the intermediate products of the pyrolysis pre-treatment enable determining the pseudo-continuous flows (in kg/hr) sent to the remaining sub-methods (4, 6, 8) of method 1, which include continuous processes, given by the ratio between the amount in kgs of each intermediate pyrolysis product and the normalized duration of the cycle (e.g., 8 hours).

Dealing in detail with the operations which, by means of example, constitute the batch pyrolysis cycle of the input waste R_IN, they include:
a charging step (typically shorter than 1 hour), wherein the reaction volume is filled, up to a predetermined volume percentage, with an amount of material not higher than the maximum capacity of the reactor, starting from the end of the previous cycle;
an inertization step (typically amounting to a few minutes), wherein the reaction chamber and all or part of the conduits and the equipment downstream are flushed with nitrogen or another inert gas, in order to remove the oxygen present therein;
a heating step (typically shorter than 1 hour), wherein energy is provided as heat by means of electric resistances (in case of a supply from a renewable energy source) or by means of combustion of a fossil or renewable combustible material, with the purpose of increasing the temperature within the chamber to the desired value for performing the pyrolysis process (typically between 400° C. and 500° C., depending on the supplied matrix);
a reaction step (typically lasting a couple of hours, but highly depending on the supplied waste), wherein the permanence and the continuous mixing of the charged material, for a given time at a given temperature, triggers complex reactions of thermal cracking, typical of the pyrolysis process, which lead to the formation of solid pyrolysis products (solid residue)—“pyro-char”, of gaseous pyrolysis products including incondensable gases (“pyro-gas”), and of liquid pyrolysis products, including condensable vapours which lead to liquid products (aqueous phase and “pyro-oil”);
a cooling and discharging step (typically shorter than 4 hours): the reaction chamber cools down naturally to a temperature compatible with the discharge of the solid residue (pyro-char) and with a safe new charging of waste.

Therefore, the products from the pyrolysis pre-treatment process 2, obtained during the work cycle or at the end thereof, comprise (FIG. 2):
a solid pyrolysis product 20, or “solid pyrolysis residue”, generally denoted as “pyro-char”, which can be characterized in terms of element composition, moisture content, total carbon, fixed carbon, volatile material, ashes, and which is destined to the NCG production process;
a gaseous pyrolysis product 22, which is generally denoted as “pyro-gas” and mainly comprises compounds which are incondensable in normal conditions (light hydrocarbons such as methane, ethane, propane, ethylene, propylene, hydrogen, carbon oxides in the case of oxygen being present in the input charge, hydrogen sulphide in the presence of sulphur, hydrochloric acid in the presence of chlorine);
one to three fractions of liquid products of organic nature, i.e., “liquid pyrolysis products” 24, generally denoted as “pyro-oils”, which are a mixture of hydrocarbons that may be characterized by the average molecular weight, the average boiling temperature, the primary physical properties (density, viscosity). The thus distinguishable liquid products may be obtained by means of successive condensations of the organic vapours developed during the reaction step mentioned in the foregoing (the condensation stages are not explicitly shown in FIG. 2 because they are generally known), and they may be classified into “heavy pyro-oil”, “middle pyro-oil” and “light pyro-oil”). The first two fractions, which are heavier, may be recirculated in the pyrolysis chamber during the work cycle itself, in order to increase the yield of the light components and maximize the amount of the third fraction, which is lighter and easier to process in the following steps;
optionally a liquid aqueous phase, which may appear if the reaction environment initially contains a certain degree of moisture or if such moisture is intrinsically contained in the starting waste.

The division of the three produced phases and the composition of the incondensable gaseous phase depend on the nature of the input waste and on the operating conditions of the pyrolysis process (temperature, duration, pressure, heating speed).

By way of example, Table 1 shows a possible distribution of the phases produced from mixed material wastes (secondary solid combustible material, or waste-derived combustible material), and from mainly plastic waste (plastic waste from agriculture). Moreover, not only the distribution among the phases, but also the composition thereof (particularly of the gaseous phase) highly depends on the nature of the material of the input charge and on the pyrolysis conditions.

The following Table shows the mass distribution (weight %) representing the intermediate products (pyro-gas, pyro-oil and pyro-char) which are expected at the output of the pyrolyser, in the case of input waste corresponding to EWC code 18.12.10 (Refuse-Derived Fuel) and to EWC codes 02.01.04/15.01.02/16.01.19/17.02.03 (Plastic Waste from Agriculture).

| | Distribution of the | | |
|---|---|---|---|
| | pyrolysis products [%] | | |
| | Pyro-char | Pyro-oil | Pyro-gas |
| Refuse-Derived Fuel, | 29 | 21 | 50 |
| temperature 500° C. | | | |
| Plastic Waste from | 8 | 43 | 49 |
| Agriculture, temperature | | | |
| 450° C. | | | |

### Sub-Method 4—Treatment Process of Pyro-Oil

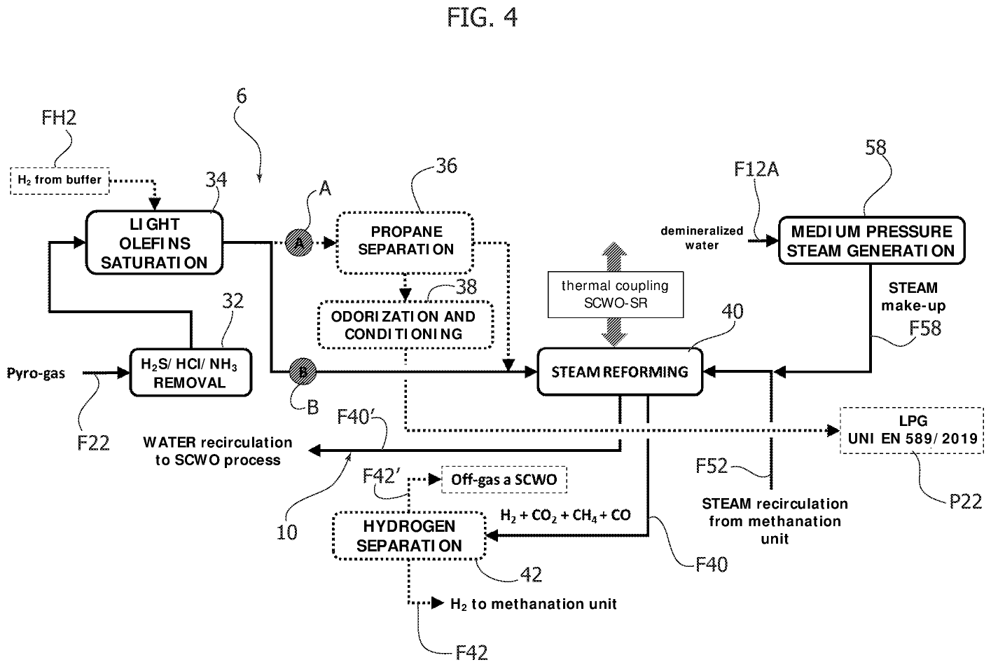

The block diagram of the treatment process of pyro-oil for the production of hydrogen is shown in FIG. 3. All the blocks and the connections shown with dotted lines may be considered as optional, albeit preferred, according to the invention.

The liquid organic fraction 24 produced by the sub-method 2 generally includes a mixture of paraffins, naphthenes, olefins, and monoaromatic, diaromatic and polyaromatic compounds having a high number of carbon atoms, which is not easily predictable in advance. Referring to FIG. 3, which shows a block diagram of the sub-method of pyro-oil treatment, there will now be described the steps to which the pyro-oil is subjected. It must be kept in mind that in some embodiments the sub-method 4 may be considered as optional: the pyro-oil may be stored for other applications without being processed. This is due to the fact that sub-method 4 has a lower functional integration degree with the other sub-methods.

The light oil produced by means of the pyrolysis pre-treatment, taken from a corresponding storage tank and represented herein as flow F24, may be initially conveniently used as a scrubbing agent (not shown in the Figure) of the off-gases of method 1, with the purpose of recovering therefrom the heavy compounds carried by the gases themselves. The resulting scrubbed off-gases are then conveyed, compressed and treated, together with the other off-gases coming from the other simultaneously executed sub-methods, in a reactor of supercritical water oxidation, or will be subjected to another technology for the abatement of exhaust gases, as will be described in the following.

Sub-method 4 envisages processing the flow 24 of pyro-oil, which is even more different from the specifications required in combustible products after the use as a scrubbing agent, is processed by means of the well-known technology of direct contact hydrogenation, so-called “hydrotreating”, block 24. The direct contact hydrogenation treatment is typically carried out in fixed-bed catalytic reactors, with the purpose of saturating the unsaturated olefinic and aromatic hydrocarbons, and of removing sulphur, nitrogen and chlorine which may be present in the pyro-oil, block 28. All hydrogenation reactions are oil, exothermic, and therefore their yield to balance is favoured by a low temperature and by the use of a large excess of hydrogen. The thermodynamic requirement of executing the hydrotreating processes at temperatures as low as possible makes it necessary to resort to catalysts adapted to increase the reaction speed even at low temperatures. One of the industrially most widespread catalysts used for this process includes cobalt and molybdenum supported on γ-alumina, and the operating conditions envisage a temperature of approximately 350-400° C., a pressure of approximately 30-50 bar and a spatial velocity of the liquid in the range of 1:3 h-1.

The reactor effluent must then be cooled down, and the unreacted hydrogen is separated from the liquid reaction products, newly compressed and recirculated to the reactor—flow F28. The liquid products are laminated to a pressure slightly higher than atmospheric, and the off-gases—flow F28′—are conveyed to be finally scrubbed with the input pyro-oil F24; the separated liquid part, with the addition of odorants and colouring agents, (block 30) and conditioned for the regulation of chemical-physical parameters and of the combustion properties, is the final product of interest, associated with the numerical reference P24 and meeting the specifications of diesel oil as per Regulation EN 590/2017.

### Sub-Method 6—Treatment Process of Pyro-Gas

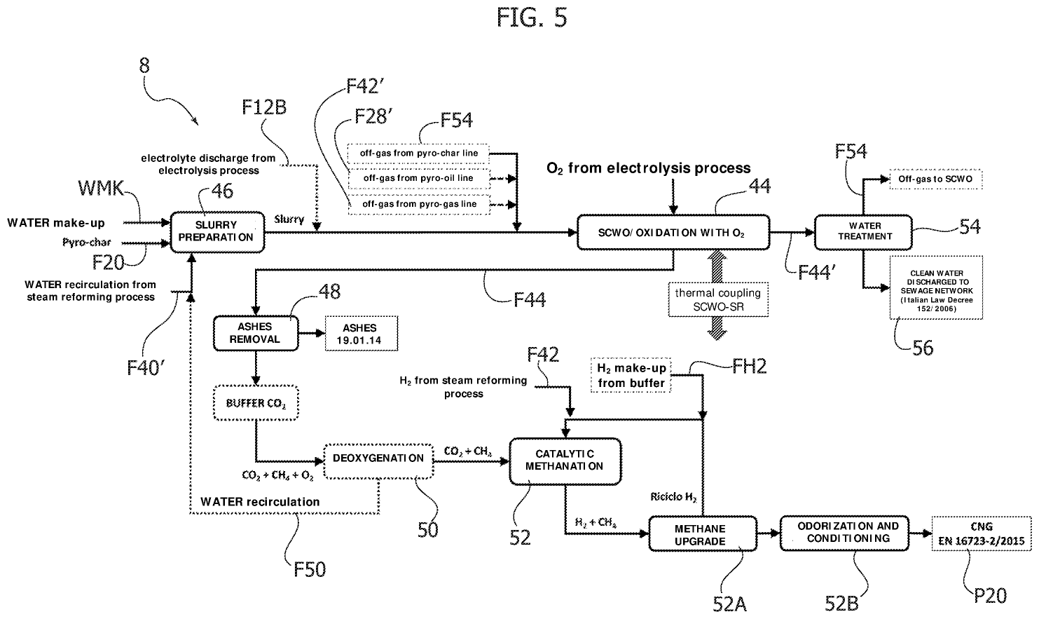

The block diagram of the pyro-gas treatment process for hydrogen production is shown in FIG. 4. All the blocks and the connections shown in dotted lines may be considered optional, albeit preferred, according to the invention.

The pyro-gas produced in the sub-method 2, especially if the flow R_IN of input waste corresponds to the EWC code 19.12.10 (Refuse-Derived Waste) may amount up to 50% by mass of the total amount of supplied material, and it comprises a gaseous mixture having a varied composition, containing alkanes and alkenes having low molecular weight (methane, ethane, ethylene, propane and propylene), hydrogen, carbon monoxide and dioxide, light nitrogen (NH₃), sulphur (H₂S) or chlorine (HCl) based gases.

In order to deal with the possible presence of the latter acid compounds, the gas is initially sent to a H₂S barrier, preferably based on iron or zinc oxides, or to another commercially available technology (for the implementation of large treatment plants, for example, it may be more convenient to choose a system for abating acid gases based on amines) and subsequently to a second HCl barrier, based on magnesium oxides or potassium carbonate or, again, to another commercially available technology. The former fixes sulphur in the form of pyrite or zinc sulphide, while the second fixes chlorine by forming magnesium or potassium chloride. The adsorbent beds must be properly sized to ensure operability for a predetermined number of work hours, depending on the nature of the starting waste. Block 32 represents—individually or globally—the H₂S, HCl barriers mentioned in the foregoing.

Actually, in the case of a supply of EWC codes relating to plastic wastes (for example CER 02.01.04, 15.01.02, 16.01.19, 17.02.03) the presence of sulphur is not generally expected at input, while in the case of EWC 19.12.10 (Refuse-Derived Fuel, RDF) the maximum concentration in this waste is predetermined by the Italian Law Decree 15 Feb. 1998 as amounting to 0.6% by weight as compared to the waste as a whole. As regards chlorine, on the other hand, in the case of plastic waste there is a high likelihood of the input waste being polluted with polyvinylchloride (PVC), and thus the presence thereof cannot be excluded; on the contrary, it is well known that the PVC pyrolysis, even at rather low temperatures (300° C.) converts up to 95% of the input chlorine into gaseous HCl, up to 5% into chloride species present in the pyro-oil and an amount lower than 1% into species present in the pyro-char (Peng Lu et al., “Review on fate of chlorine during thermal processing of solid Journal wastes”, of Environmental Science, 2018). Finally, in the case of RDF supply, said Italian Law Decree fixes the maximum content of chlorine to a maximum 0.6% by weight with reference to dry matter.

The pyro-gas continuously produced during the pyrolysis cycles, flow F22, is therefore obtained as a mixture of incondensable light gases due to the separation from the condensed vapours of light oil (pyro-oil), and is conveniently and temporarily stored in a pressurized tank or in a gasometer at atmospheric pressure, acting as a buffer to dampen the flow variations and to make the gas composition uniform. The operating pressure of the tank may be varied within a given range, so as to ensure regulating the withdrawal of a constant flow, which is continuously supplied to the following process units.

In a first embodiment of sub-method 6 (reference A in FIG. 4), which is preferred if such gases contain a high quantity of propane and higher alkanes, the pyro-gases, purified from the sulphur and chlorine species, are fed to a process unit which carries out the catalytic saturation of the light olefins (ethylene, propylene, butenes-block 34, optionally with a hydrogen make-up FH2 from buffer BH2), operating with hydrogen in stoichiometric excess in comparison with the other hydrocarbons. After the saturation of the unsaturated hydrocarbons, propane and higher saturated hydrocarbons (butanes and pentanes, if present) are separated from lighter hydrocarbons (hydrogen, methane, ethane), block 36, thereby obtaining a product P22 containing the required odorants and additives (block 38), meeting the specification EN 590/2017 for liquid propane gas (LPG). Substantially, in such embodiments, net of the other operations, the propane is extracted from flow F22 for the following production of LPG.

On the other hand, the mixture of gases separated from propane is destined to a process of reforming, known in itself, specifically to steam reforming, for the quantitative conversion into hydrogen and carbon oxides-block 40. If the waste input to the pyrolysis pre-treatment of sub-method 2 is mainly composed of plastics (e.g. EWC codes of the types 02, 15, 16 and 17), this would lead to a pyro-gas very rich in ethane, ethylene, propane and propylene, which as is well known have a yield and a rate of conversion into hydrogen which are much higher than methane, which is anyway present. Instead of steam reforming it is possible to perform a catalytic gasification, because steam reforming functionally works as a thermochemical gasification. Generally speaking, in the method according to the invention, flow F22 is subjected to a reforming for the quantitative conversion into hydrogen and carbon oxides, i.e., for the generation of a synthesis gas. The reforming may be carried out by means of steam reforming, thermal reforming or catalytic gasification (e.g., supercritical water gasification).

In a second alternative embodiment of sub-method 6, associated to reference B in FIG. 4, which is preferred if the pyro-gases are so poor in propane and higher alkanes as to make the separation thereof inconvenient and difficult, the pyro-gases are integrally supplied, preferably after a treatment in a stage of saturation of light olefines, block 34, to the process of steam reforming (or generally speaking of gasification) of block 40.

Generally speaking, both embodiments described herein must be understood as alternatives, because it is possible and useful to establish a minimum threshold of propane and butane content in the gas mixture, above which it is useful to adopt sub-method A and below which it is better to resort to sub-method B.

If the waste R_IN supplied to method 1 belongs to the EWC class 19, it is expected to have a pyro-gas flow F22 which is richer in methane and carbon oxides than it is in higher alkanes, but it is anyway convenient to send such flow to the steam reforming reactor in order to produce hydrogen, obviously suitably regulating the residence time in the reactor.

In this regard, if the steam reforming of block 40 has a modular structure, it is possible to adapt the reaction volumes in order to ensure the residence times suitable for the specific flow and composition supplied. Irrespective of the nature of the input waste, therefore, at least a part of the pyro-gas flow F22 is sent to steam reforming, after desulphurization and dechlorination in the respective barrier beds.

By means of steam reforming, actually, and specifically by acting on the reaction times, the composition of the input gas (in the present case of the flow F22) is modified, thereby increasing the amount of hydrogen to the detriment of the amount of ethane/ethylene, propane/propylene and higher alkanes/olefins. This enables saving the power consumption required for the production of hydrogen by means of electrolysis of demineralized water (block 12B).

The steam reforming reactor, in addition to the pyro-gases F22 purified from the acid species, also receives medium-pressure steam, which takes part to the reforming reactions of methane and higher hydrocarbons. A substantial part of the steam necessary to the process may be obtained from the aqueous phase produced, separated and vaporised by means of a methanation process, which will be detailed in the following description of sub-method 8, and from the circulation of aqueous flow as per reference 10. The medium pressure steam make-up, which must be added to support the steam reforming reactions (the process requires a net consumption of water) can be obtained by recovering thermal energy from the effluent of a supercritical water oxidation process, or of another oxidation process performed with pure oxygen as a combustion agent, to which the steam reforming process may be conveniently and easily thermally coupled. Further details will be given in the description of sub-method 8 and of the circulation of aqueous flow as per reference 10.

By way of example, in one possible embodiment, the steam reforming reactor is a tubular thermal converter, of the type having piston flow, operating at a temperature of 580-650° C. and at a pressure of 16-24 bar. The reaction temperature may be preserved by means of a direct thermal integration with the supercritical water oxidation reactor, or with the combustion agent made of pure oxygen, and with local heating actions by means of electrical resistances, if needed.

After cooling and separating the water condensed in the steam reforming process (flow F40′), the gaseous effluent of the steam reforming reactor, corresponding to flow F40, is separated into hydrogen (which constitutes the main volume of the mixture)—block 42, flow F42—and off-gas (a mixture which is predominantly composed of carbon oxides and methane) block 42, flow F42′—which are wholly recirculated. Flow F40 mainly includes hydrogen and carbon dioxide; depending on the reforming conditions, there may be present a small part of methane CH₄ and carbon monoxide CO.

The last operation of separation of hydrogen produced by means of steam reforming as per block 42, shown in dotted lines in the diagrams of FIG. 1 and FIG. 4, is to be considered optional depending on a series of factors and considerations, which are purely technical-practical and economical, among which the commercial technological availability of efficient solutions for the following methanation operation, the strategy adopted as regards the emissions into the atmosphere (authorized emissions vs. zero emissions), the primary energy source (renewable vs. fossil, self-produced vs. supplied by third parties), the economical sustainability of the investment. In this regard, indeed, according to the technological solution adopted for the following process of catalytic hydrogenation (e.g., methanation) and according to the execution safety thereof—as will be better detailed in the following—it may be sufficient to simply remove the condensed water from the steam reforming effluent, without the need of separating hydrogen from other unreacted gases. By way of example, among the potentially adoptable techniques for the separation of hydrogen from carbon dioxide it is possible to mention the so-called Pressure Swing Adsorption, the membrane separation and the absorption with aqueous solution of amines.

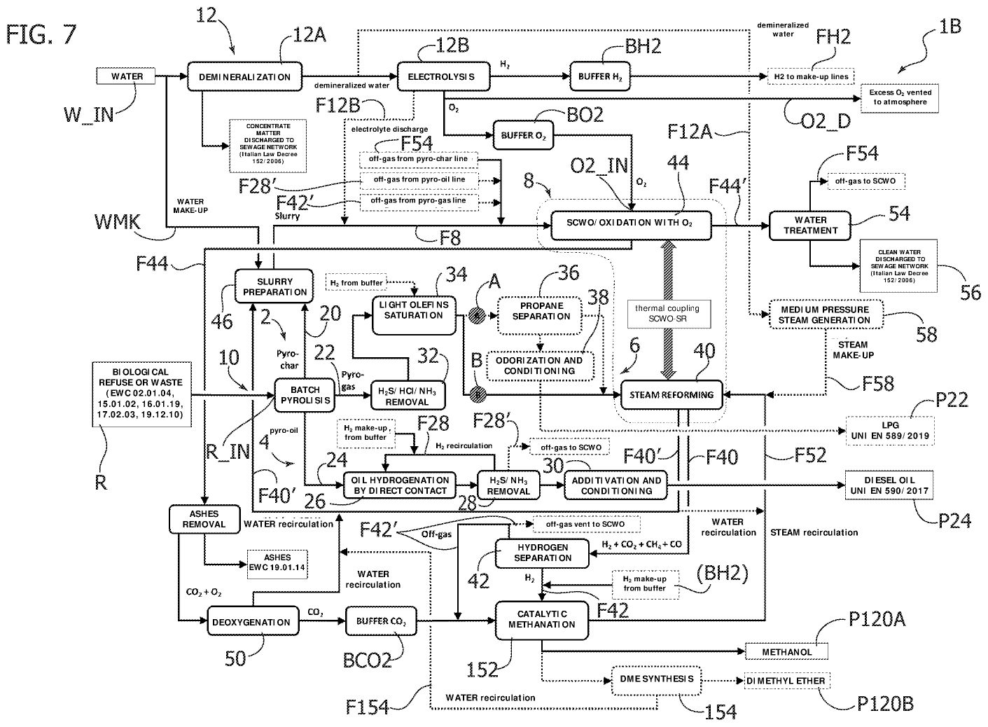

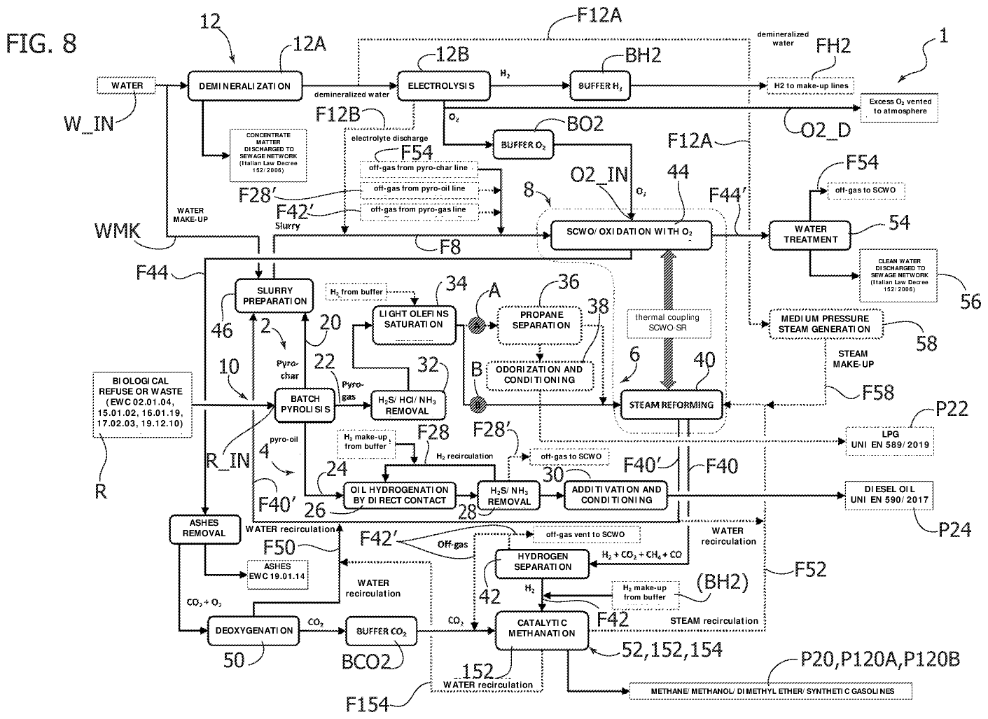

In any case, the hydrogen thus produced (which may be separated or mixed with other gaseous products of steam reforming) is used as a reagent in the process of catalytic hydrogenation (catalytic methanation in the embodiment of FIG. 1), which has the function of converting the carbon dioxide produced in the oxidation process into supercritical water, or in another oxidation process carried out with pure oxygen (by means of oxidation of the carbon which is intrinsically contained in the pyrolysis residue of the starting waste), the carbon dioxide produced by the steam reforming, the carbon dioxide naturally contained in the pyro-gas, and all the carbon dioxide which in any way may be caught and retained by the remaining process lines (for example in all the off-gases collected in the separation operations), into methane, i.e., the preferred final gaseous product of interest, or—with reference to FIGS. 6 and 7 (wherein the blocks and the connections shown in dotted lines may generally be considered optional, albeit preferred) into another fuel and/or product such as methanol, dimethyl ether (DME), synthetic gasolines, if the sub-method of catalytic oxidation is replaced by another sub-method of catalytic hydrogenation (the catalytic methanation is a possibility of catalytic hydrogenation according to the invention), or by another sub-method for the conversion of CO₂ other than hydrogenation. In this regard, FIG. 8 (wherein the blocks and the connections shown in dotted lines may generally be considered optional, albeit preferred) schematically shows a generalization of the method as regards the treatment of the gaseous flow the F40: related reference 52, 152, 154 denotes on the whole a general process of catalytic hydrogenation, and the related reference P20, P120A, P120B summarizes the combustible products which may be obtained downstream the catalytic hydrogenation.

### Sub-Method 8—Pyro-Char Treatment Process

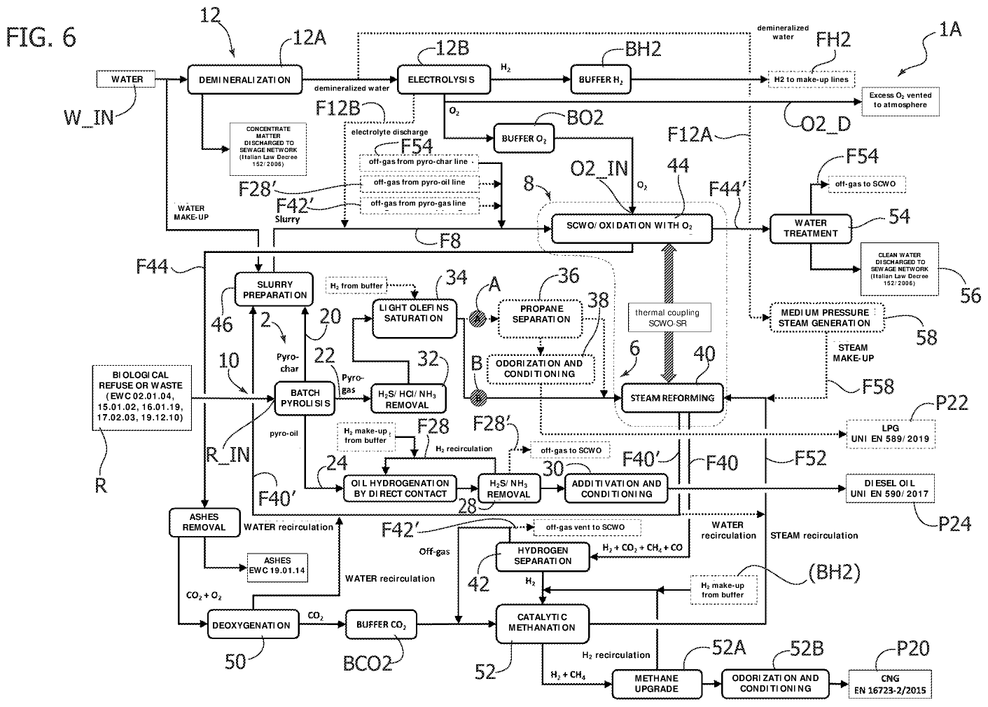

FIG. 5 shows the block diagram of the treatment process of the pyrolysis solid residue (pyro-char), the final product of interest whereof, P20, is compressed natural gas meeting the specifications for entering a distribution network (EN 16723-1/2015) or for automotive use (EN 16723-2/2015).

Sub-method 8 envisages, as a main step, an supercritical water oxidation (block 44) or else a conventional oxidation of pyro-char performed with pure oxygen as a combustion agent, in order to obtain a single exhaust gas including nearly pure carbon dioxide (containing only traces of unreacted oxygen and possible traces of unoxidized methane).

The process of pyro-char treatment, in 8 combination with the process 6 of pyro-gas treatment described in the foregoing, combines two technologies that so far have never been adopted simultaneously and jointly in one and the same process, i.e., the oxidation of the carbon particulate (performed in an atmosphere of pure oxygen or in supercritical water with pure oxygen) and the steam reforming (block 40) of the paraffins and of the light olefins. This combination of processes enables an efficient treatment, in a zero-waste method, of the solid and gaseous intermediate products of the preliminary pyrolysis treatment: the solid residue (pyro-char) is suspended in an aqueous solution—block 46—wherein the aqueous fraction includes a collection of all the exhausts of the units of the integrated method as a whole, while the incondensable gaseous phase (pyro-gas) is supplied, as previously stated, together with water vapour to the steam reforming process for the production of a flow rich in hydrogen, with possible traces of methane and carbon dioxide, which will be routed to a final methanation process, as will be better detailed in the following.

In a preferred embodiment, the pyro-char is supplied, in the form of aqueous slurry (flow F8), previously prepared by mixing to a desired concentration, to a unit for supercritical water oxidation (SCWO).

The aqueous slurry comprises the flow F24 of the pyrolysis solid products, mixed with a first aqueous flow, comprising a second aqueous flow corresponding to the flow F40′, i.e., an effluent of the steam reforming process (and thus an aqueous flow separated from the products of gasification) and with a third aqueous flow which is directly taken from the supply W_IN of the sub-method 12. In any case, it must be considered that the second flow may be, partially or totally, recirculated to the reforming stage, particularly when the latter is implemented by means of steam reforming. An example of such recirculation is shown in FIGS. 6 and 7, but is equally applicable to the diagram of FIG. 1.

Together with the pyro-char there is supplied a part of the oxygen produced by the electrolysis unit, together with all the conveyed off-gases coming from the pyro-oil treatment (flow F28′) and the pyro-gas treatment (flow 42′). As has been observed in the foregoing, the oxidation in a supercritical aqueous environment may be replaced with a traditional oxidation at ordinary pressure, in a suitable combustor, provided that the combustion agent is always pure oxygen, in order to produce solely carbon dioxide as a combustion product of carbon. In this case, anyway, the possibility is not excluded of the formation of atmospheric pollutants, such as nitrogen and sulphur oxides, if such elements are present in the pyro-char to be processed, therefore requiring further treatments for the abatement of gas. The oxygen is supplied by buffer BO2, flow O2_IN, and it is therefore oxygen produced by electrolysis at block 12B. It is to be understood, however, that the oxygen flow may be supplied in other ways, it being unnecessary for the oxygen to be produced by means of electrolysis.

The concentration of pyro-char in the aqueous slurry is conveniently and preferably comprised in the range of 5÷15% by mass, though the possibility is given of reaching up to 25% of suspended solids, and it is supplied to the supercritical water oxidation unit (in the preferred embodiment) after pre-heating by means of the heat recovered from the effluent of the steam reforming unit of sub-method 6, thermally integrated therewith, and/or by means of the heat recovered from the effluent of the SCWO unit itself.

In the supercritical water oxidation process, the carbon content in the supplied organic matrix is converted exclusively into carbon dioxide, with abatement yields higher than 99.99%, because the reaction environment is a homogeneous mixture predominantly comprising water (at least 80% by mass) at a typical operating pressure of 240÷250 bar and at a temperature of 500÷700° C. In such conditions, the water can solubilize the organic matter, therefore obtaining a homogeneous mixture, wherein the oxidation of carbon to carbon dioxide may take place with a “controlled” radical such that the only gaseous carbon compound in the product is finally carbon dioxide. The high excess of water allows the latter to be the main reaction means, adapted to orient the reaction path towards harmless gaseous products (essentially nitrogen and carbon dioxide) which do not require further important treatments before being discharged into the atmosphere.

The oxidation process, unlike incineration, is a totally confined process which takes place in a limited space and at well defined and controllable conditions, enabling obtaining gaseous and liquid effluents at temperatures and pressures close to atmospheric. The operating temperatures of the process are too high to lead to the formation of dioxins and too low to lead to the formation of nitrogen oxides: chlorine and nitrogen, which may be present in the supplied charge (flow F8) are respectively converted into hydrochloric acid and molecular nitrogen, the former being then completely dissociated in the exhaust aqueous phase. Similarly, the sulphur which may be present at input (flow F8) forms, at the reaction conditions, sulphuric acid, which is totally dissociated in the aqueous solution: the result thereof is the absence of sulphur oxides in the gaseous effluent, which leads to important benefits as regards both the plant and the environment.

Referring to FIG. 5, it will be observed that the supercritical water oxidation process within method 1 (or any other oxidation process) brings about the abatement of exhaust gases, together with all the other off-gases produced by the other sub-methods included in the integrated method (off-gas flows F42′, F28′ and F54). In this way, the process of supercritical water oxidation is employed not only for processing the solid residues of pyrolysis, which would otherwise be routed to other uses and/or other processes of disposal/recovery, but also as a line of gas treatment and abatement, because the supercritical water oxidation is one of the “best available technologies” in this field. The process water separated from the steam reforming effluent may be recirculated to the same process of supercritical water oxidation (SCWO) in order to prepare the carbon-containing slurry (flow F8) supplied thereto, or it may be totally or partially recirculated to the steam reforming process itself, in order to integrate the aqueous phase which is anyway recovered and recirculated in the following methanation process.

Although the processes of supercritical water oxidation and of incineration lead to the same result (i.e., to the volume reduction of a waste by means of thermal destruction of organic matter), unlike the latter the supercritical water oxidation process does not produce slag or solid by-products of any kind, apart from inert ashes (flow F44, corresponding to a gaseous flow taken from the oxidation products) consisting in traces of metal or non-metal elements oxidized at their maximum level. At the exit of the reactor, the oxidized flow corresponding to flow F44 and unreacted oxygen, beside and containing CO₂ possible small percentages of methane from off-gas which has not been totally converted (because it is rather resistant to the supercritical water environment) is cooled and processed—block 48—in a system of gas-solid separation (by way of example of a cyclonic kind), in particular for the separation of ashes, operating at high pressure so as to take advantage of the insolubility of salts and ashes in supercritical water.

An ashes separation system must be provided also when the chosen oxidation technology is not supercritical water oxidation but rather an ordinary oxidation in pure oxygen atmosphere. The ashes and the inert salts, the more abundant the richer in heteroatoms and heavy metals the waste input to the pyrolysis process, are in this case a production refuse which is still classifiable as waste according to the European Waste Catalogue.

After further cooling, while keeping the system under pressure in order to separate a substantial part of the reaction water, a diphasic flow is obtained wherein both the liquid and the gaseous components are laminated at a pressure close to the operating pressure of the following methanation process. The gas content and all the gases which may have formed during the cooling and the depressurization procedures are conveyed, with the possible integration of a small hydrogen make-up (if necessary, not shown in FIG. 1 and in FIG. 5) to a (preferably catalytic) converter, block 50, wherein the residual oxygen is removed by means of reaction with the hydrogen itself or with part of the methane which is present, thus producing further water and/or carbon dioxide.

Such a deoxygenation operation, shown in the diagram of FIG. 1 as a block 50 in dotted lines, is not necessary if the process of supercritical water oxidation is performed with exactly stoichiometric or with insufficient oxygen, or if the oxidation is performed with a conventional technology (i.e., not in a supercritical aqueous environment). In this case, however, it is impossible to ensure a complete abatement of the organic content (Total Organic Carbon, TOC) of the input slurry (flow F8).

If the whole integrated method is supplied with electric power integrally produced by a photovoltaic field, because of the intrinsic unpredictability of the sun irradiation, in combination with or as an alternative to a battery power storage device it is convenient to envisage an interception system for a part of the gaseous flow exiting the SWCO unit, to route it to a temporary storage system. In a first embodiment of the invention, such an interception system (reference BCO2) is installed immediately upstream the deoxidation process (block 50), i.e., as long as the gas line conveying flow F44 is still highly pressurized. In this case, the mixture to be stored is in a gaseous aggregation state, and therefore it is preferably stored in bundles of high-pressure cylinders, in order to be withdrawn later according to needs.

In a second embodiment 1A of the invention, specifically depicted in FIG. 6, the storage system BCO2 is installed immediately downstream the deoxidation process (block 50) because the mixture is devoid of oxygen and therefore liquefies easily. In this case the mixture, which solely comprises carbon dioxide (apart from traces of hydrogen) is condensed and refrigerated, and it is sent to a cryogenic storage tank, operating at a pressure which is definitely lower than the bundle of cylinders of the previous case. Afterwards, according to needs, the stored carbon dioxide may be taken, vaporized in a suitable vaporizer and sent to the following sub-method.

In this way, a subsequent unit of catalytic methanation (block 52) may receive only and exclusively the amount of carbon dioxide of flow F44 which can actually be converted into methane, by reaction with the sole hydrogen produced by steam reforming in the sub-method 6, integrated with the amount of hydrogen actually and instantaneously produced by electrolysis at block 12B.

The effluent of the oxygen catalytic converter of block 50, which operates at the same line pressure as the following methanation unit of block 52, net of the load losses, exclusively contains carbon dioxide, water vapour and traces of oxygen and methane, and it is sent to the methanation unit of block 52.

On the other hand, the liquid part taken from the flow of oxidation products (which in the present case derives from the supercritical water oxidation (SCWO) stage of block 44), i.e. flow F44′, is laminated to a pressure close to atmospheric, in order to be subsequently sent to a water treatment unit (block 54) wherein it may be brought to neutralization with a base (for example calcium carbonate or sodium hydroxide), then it is filtered and clarified, before the final discharge into the sewage system, according to the specifications imposed by the Italian Law Decree 152/2006, block 56. A possible flow of off-gas F54 released by the water treatment unit is recirculated to the oxidation reactor of block 44.

The methanation unit of block 52 preferably comprises one or more adiabatic reaction stages, with fixed catalyst beds with ruthenium supported on alumina, which is highly selective towards methane in comparison with carbon oxides and which is active even at low temperatures and less prone to sintering and deactivation due to coke deposition in comparison with a nickel catalyst, which however may be an alternative solution.

The methanation stages are supplied in parallel as regards the flow of carbon dioxide and in series as regards the flow of hydrogen, or vice versa, so that one of the reagents is always present in high excess, in order to easily control the reaction degree and manage the thermal effects.

In the first case, for example, the flow of hydrogen corresponding to flow F42, comprising the effluent from steam reforming integrated with a hydrogen make-up FH2 (from buffer BH2), produced by means of electrolysis at block 12B, is totally provided to the first methanation stage. At the output of each of the multiple reactive stages, the process flow is cooled so as to separate the water which has formed and to provide the gaseous fraction to the following stage. Each of the condensed water flows is recirculated and vaporized at the expenses of the heat released by the same methanation effluent of the corresponding reactive stage (recirculation flow F52, FIG. 4, input into the steam reforming stage 40), so as to be reused as medium pressure steam (16-24 bar) recirculating in the steam reforming unit. Moreover, a stage may be advantageously provided of pressure medium steam generation, represented by a block 58 in FIG. 4, which leads to the production of medium pressure steam (16-24 bar)—flow F58—which, together with flow F52 recirculated from methanation stage 52, composes the medium pressure steam flow input into the steam reforming stage 40.

On the other hand, the gaseous part effluent from the methanation unit is the product of interest, which is still raw and must be subjected to upgrade, as it contains the produced methane, the unreacted hydrogen in excess and traces of carbon and water. This flow, denoted by reference F52′, is therefore fed to an integrated system for dehydration, and finally to an upgrade unit (block 52A), e.g. based on the membrane separation technology (so-called Gas Permeation), adapted to separate hydrogen and carbon dioxide from methane, which is finally ready to be odorized (block 52B) and compressed in bundle of cylinders at a pressure of 200-220 bar, according to the Specifications EN 16723-2/2015, or to be input into distribution networks according to the Specifications EN 16723-1/2015, thus defining a further product P20 of the method according to the invention.

In a third embodiment 1B of the invention, shown in FIG. 7 as an alternative to the embodiments shown in FIGS. 1, 6, the hydrogen flow F42 produced in the separation stage 42 and the carbon dioxide flow coming from the deoxidation unit 50 or taken from the storage system BCO2 (depending on whether the embodiment is implemented as shown in FIG. 1 or in FIG. 6) may be destined to another sub-method of catalytic hydrogenation other than methanation, for the production of a combustible product other than methane. Such alternative method may include, by way of example, a method for the production of methanol (used as a thinner, additive or fuel, block 152 and product P120A), or a method for the production of dimethyl ether (equally used as an additive or fuel, block 154, product P120B), or a Fischer-Tropsch Synthesis method, wherein the hydrogen and carbon dioxide mixture is initially converted, in the presence of a catalyst, into a synthesis gas comprising hydrogen and carbon monoxide, and is subsequently converted, again by means of a catalytic process, into liquid synthetic fuels (e.g., gasolines).

The skilled in the art will appreciate that method 1 according to the invention is configured as an integrated method for the production of fuels, for automotive uses or for the input into a network, from the recovery of waste, and is characterized by:
the integration of various treatment processes (or sub-methods) such as the sub-methods 2, 4, 6, 8, for the most part belonging to the industrial “best practice” treatments for the recovery, the exploitation and the disposal of organic waste, in order to achieve a global method preferably having zero emissions or controlled emissions;
the definition of the conditions needed to implement discontinuous pre-treatment processes (pyrolysis, sub-method 2) together with continuous conversion processes (hydrotreatment, SCWO, steam reforming, methanation) in the products of interest;
the combination, within one single productive method, of an exothermal process of disposal/abatement of combustible solid residues (pyro-char oxidation, sub-method 8) and of an endothermal process for the production of hydrogen from paraffins and light olefins (steam reforming of the pyro-gas or of derived products thereof, sub-method);
the possibility of an integral or partial supply from a renewable energy source (photovoltaic/wind energy, block 14), associated with a power storage system 16 and an emergency electric generator 18 with a fossil energy source.

Moreover, the possibility of taking advantage of specific incentives from the Italian Energy Service Manager (GSE), linked to the emission of Italian Certificates of Release for Consumption (CIC) of fuels or biofuels obtained from other fuels having non-biological origin and/or from renewable energy sources, may make method 1 sustainable even when it is implemented in small-sized plants, otherwise could not support the scale economy.

Of course, the implementation details and the embodiments may be amply varied with respect to what has been described and illustrated herein, without departing from the scope of the present inventions, as defined in the annexed claims.

1. A method for conversion of organic waste and/or biological waste into combustible products, comprising:
feeding a first flow including organic waste and/or biological waste,
performing a pyrolysis of said first flow to obtain one or more liquid pyrolysis products, one or more gaseous pyrolysis products, and one or more solid pyrolysis products,
mixing said one or more solid pyrolysis products with a first aqueous flow, and subjecting the mixture to oxidation to obtain oxidation products,
taking a first gaseous flow from said oxidation products,
subjecting said one or more gaseous pyrolysis products to reforming, thereby obtaining one or more reforming products,
taking a second gaseous flow from said reforming products, and
subjecting said first gaseous flow and said second gaseous flow to catalytic hydrogenation to obtain at least one first combustible.

2. The method according to claim 1, further comprising taking a second aqueous flow from said reforming products, and routing said second aqueous flow to mixing with said one or more solid pyrolysis products, said second aqueous flow defining at least part of said first aqueous flow.

3. The method according to claim 1, further comprising subjecting said one or more liquid pyrolysis products to hydrogenation to obtain a second combustible, including diesel oil.

4. The method according to claim 2, wherein said oxidation comprises a supercritical water oxidation.

5. The method according to claim 4, wherein said supercritical water oxidation occurs in a heat exchange relationship with said reforming, whereby a heat input of said reforming comprises heat released by said supercritical water oxidation.

6. The method according to claim 1, wherein said one or more gaseous pyrolysis products are subjected, prior to said reforming, to a separation of propane to obtain a third combustible, including LPG.

7. The method according to claim 1, wherein said reforming comprises one of:
steam reforming,
catalytic gasification,
supercritical water gasification, and
partial oxidation.

8. The method according to claim 7, wherein said steam reforming is supplied by means of a steam flow resulting from said catalytic hydrogenation.

9. The method according to claim 2, further comprising feeding a third aqueous flow to mixing with said one or more solid pyrolysis products, whereby said first aqueous flow comprises said second aqueous flow and said third aqueous flow.

10. The method according to claim 9, wherein said third aqueous flow is drawn off a main water supply, the process further comprising subjecting said main water supply to electrolysis to obtain gaseous hydrogen and gaseous oxygen.

11. The method according to claim 10, further comprising feeding said gaseous oxygen to a reactor which carries out said oxidation of said mixture of the one or more solid pyrolysis products and the first aqueous flow.

12. The method according to claim 1, wherein said first gaseous flow comprises carbon dioxide.

13. The method according to claim 1, wherein said second gaseous flow comprises carbon dioxide and hydrogen.

14. The method according to claim 12, wherein said first gaseous flow further comprises oxygen, the method further comprising subjecting said first gaseous flow to deoxygenation before being subjected to catalytic hydrogenation to obtain the at least one first combustible.

15. The method according to claim 1, wherein said catalytic hydrogenation comprises:
a process of catalytic methanation,
a methanol production process,
a dimethyl ether production process, and
a Fischer-Tropsch synthesis process.
